(19) United States
(12) Patent Application Publication
(10) Pub. No.: US 2011/0161148 A1
(43) Pub. Date: Jun. 30, 2011

(54) Method and system for providing incentives

(76) Inventor: Edward D. Schmidt, San Francisco, CA (US)

(21) Appl. No.: 12/799,301

(22) Filed: Apr. 22, 2010

Related U.S. Application Data
(60) Provisional application No. 61/335,036, filed on Dec. 30, 2009.

(51) Int. Cl. G06Q 30/00; G06Q 99/00; G06Q 50/00

(52) U.S. Cl. 705/14.16

(57) ABSTRACT

A method for obtaining new users of an online system within a socially networked environment. New users are registered and associated with a registered user. A status level is formed as a function of the number of new users associated with the registered user. The status level can have thresholds, or depends on the status level of the associated registered users. Incentive rewards can be determined based on the status level. The status level of each registered user can be visible to each other user thereby forming a social environment based status level.

### RELATED APPLICATIONS

This Patent Application claims priority under 35 U.S.C. 119(e) of the co-pending U.S. Provisional Patent Application, Ser. No. 61/335036 filed Dec. 30, 2009, and entitled: “Method and System for Providing On-line Content.” The Provisional Patent Application, Ser. No. 61/335036 filed Dec. 30, 2009, and entitled “Method and System for Providing On-line Content” is also hereby incorporated by reference.

### BACKGROUND OF THE INVENTION

This invention relates generally to electronic processing systems implementing a method of incentivizing new user registration with an online system. One attribute that can contribute to the economic value of an online system is the number of users utilizing the system and the incentives that effect the social interactions between the users. A system and method that provides an environment where registered users of an online provider are motivated to register new users is beneficial to the providers of such online systems.

### SUMMARY OF THE INVENTION

A method for obtaining new user registration with an online provider by forming an association between a new user registration with a registered user and providing incentive rewards based on the associations or formed status level is described. An online provider supplies a means for registering new users with the online provider. An association is made between a new user and the registered user. Either a means is provided for the new users to select the registered user for a user association or a means is provided for the registered user to specify potential new users where a user association is made when the potential new user registers as a new user. Further, the online provider can supply additional registered user information to the registering new user for aiding the selection of one of the registered users. For example, the new user may want to select a registered user that has a higher status within the online provider, one who lives in a specific geographic area, who is a friend, someone recommended to the new user, someone who has a common social interest, common profession, or a common business.

The online provider forms a user accounts and records an association between each registering new user and a registered user. The user association can take on a number of forms and structures. The associations can be limited to a count of associations formed between new users with the registered user. Further, the association can include other information provided by the new user during registration. Additionally, the additional information provided by the registered user includes but is not limited to name, address, and time and date information when the new user registered, and status level of the registered user. This information can change dynamically after a new user registers.

A status level is determined for a registered user based on each of the user associations formed when a new user registers with the online provider. The status level can be formed based on the number of associations formed by newly registered users, or can be based on a combination of factors including but not limited to the length of time of a user associations, and the other attributes of associated registered users such as their status level. The status level can be a linear function of the associations, a step function of based on threshold levels of number of user associations, or a time weighted function of each of the users associations.

An incentive reward can be given to a registered user as an incentive to register additional users. The reward can be determined as a function of the registered user's status. Alternatively, the reward can be based on the user associations. The user associations information can include an just the number of user associations formed or can include a combination user associations and the associated status level of each associated new user, and other attributes including how long the new users have been registered or the amount of purchase activity by the new user. Thereby, the rewards can be used to reach different objectives of the online provider such as increasing the number of new user registration or incentivizing new users to stay registered for longer. The incentive rewards can be points or credits that can be used to redeem a physical or electronic content from an online stores including but not limited to video product relating to teenage life such as first dates, dating, and fashion. The store can be an associated with the online provider and containing related content. Exemplar content includes content with a related theme such as fashion videos, skin care videos, make up videos, modeling videos, acting videos, personal development videos, self-improvement videos for teenagers and physical products including but not limited to bags, T-shirts, and skin care products.

### BRIEF DESCRIPTION OF THE DRAWINGS

FIG. 1 illustrates an exemplar environment for an online system within a socially networked environment for obtaining new users by forming a status level based on associated new users and providing rewards as incentives.

FIG. 2 is a flowchart illustrating an exemplary process of registering, generating and receiving and redeeming incentive rewards in accordance with some embodiments of the present invention.

FIG. 3 illustrates an exemplary operating environment in which users are registered, credit given, and content accessed and purchased in accordance with some embodiments of the present invention.

### DETAILED DESCRIPTION

A method of and system for obtaining new users of an online system within a socially networked environment is provided. A new user registers with the online provider. A user association is made between the newly registered user and the registered user. A number of different means can be used by which either the new user indentifies the registered user, a registered user identifies a new user, or a registered user identifies a potential new user. The associations between registered users form a social network where there are incentives for registering new users. Preferably a user association is made at the time a new user registers with the online provider. However, the user association can be made after the new user registers with the online provider. Each of these different means of forming an association contributes to the different social interactions and incentives for registering new users within a networked environment.

Upon registration, a new user becomes a registered user and an initial status level can be assigned during or after the registration process. A status level is associated with the registered user based on the number of user associations made through registering new users. The new user can be assigned an initial status level at registration or a status level can be assigned after registration. The status level for the registered user is changed as other new users register and additional user associations are made with the registered user. The more new users associated with a registered user, the higher the status level assigned to the registered user. With each status level, there are associated rewards provided by the provider of the online site. These rewards are redeemable for, but are not limited to, electronic reward points, incentive points, credits, payments, additional system or membership rights, access to internet or system materials including electronically streamed content, physical content provided through a physical delivery system. Preferably the content is provided by an associated online store but can be provided by a non-associated online store through electronic payment systems for example Paypal®, Visa® or Mastercard®. In one embodiment the content is related to acting videos, modeling videos, fashion videos, or self-improvement videos such as video lessons on various aspect of teenage life including but not limited to dating, fashion, and money.

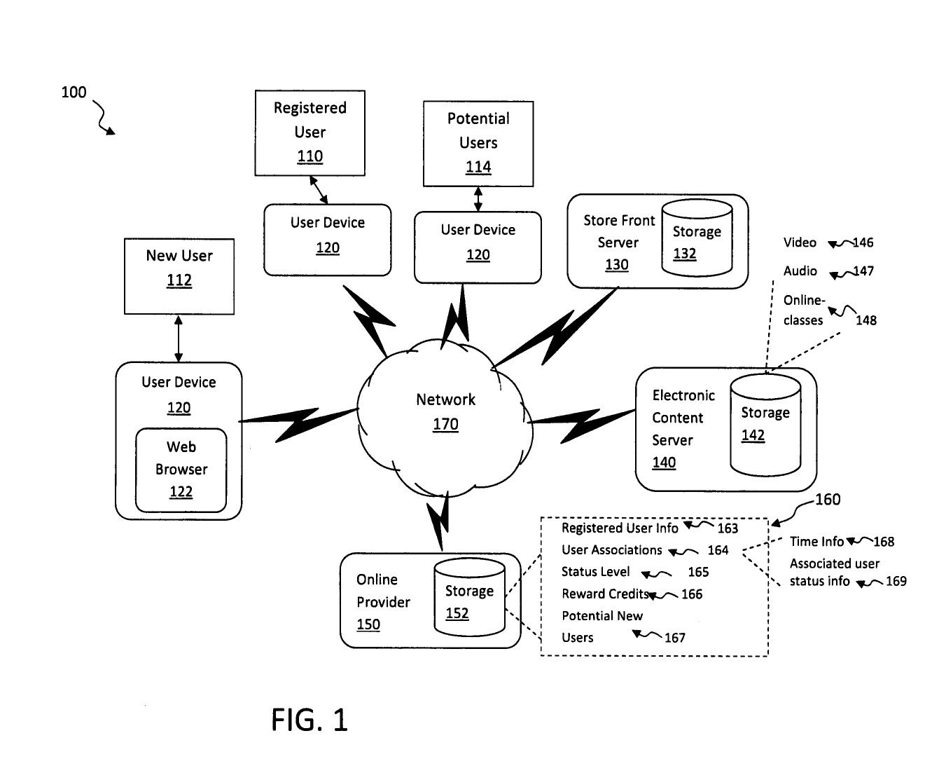

FIG. 1 illustrates an exemplary environment 100 for obtaining new users of an online system within a socially networked environment. One or more new users, such as new user 112, utilize a user device 120 to couple with an online provider 140 through an electronic network 170 such as the Internet. Examples of the user devices 120 include but are not limited to personal computers, laptops, smart phones, and PDAs (person digital assistants). The user device 120 has a user interface (such as a Web browser 122) for providing and receiving information to and from the online provider 140. This information includes but is not limited to new user information, information indentifying a registered user, and receiving information from the Online Provider including but not limited to lists of registered users and associated status levels, professional information, and geographic location information.

The online provider 140 can represent any web site or electronically networked service that registers users and has a need to attract additional registered users. In one embodiment the exemplary environment 100 provides a social community for a plurality of new users 112, previously registered user 110, and potential new users 114 to interact. Further, the exemplary environment 100 can provide online shopping services where registered users 110 can redeem reward credits 166 that have been provided as an incentive for registering new users 112. In one embodiment, the rewards credits 166, can be redeemed from a Store Front Server 130 that provides online shopping services. The electronic shopping services can include physical or electronic content. In yet another embodiment, the online stores are associated with the online provider 140 and provide a related theme of merchandise and services such a modeling, fashion, and self-improvement products including but not limited to video lessons relating to aspects of teenage life such as teenage first dates and teenage fashion. The Store Front Sever 130 is shown as a separate server but can run on the same hardware as the online provider 140 server.

In another embodiment, the reward credits 166 are redeemable for streamed or downloaded content. As shown in FIG. 1, the electronic content is provided by an Electronic Content Server 140. The electronic content can include but is not limited to videos 146, audio 147, and online classes 148. Preferably, the content is related to acting videos, modeling videos, self-improvement videos, and videos on aspects of teenage life including but not limited to teenage first dates and teenage fashion. While the Electronic Content Server 140 is shown as a separated device, it can be collocated with the Online Provider 150 and the storage 142 shared with the storage Online Provider storage 152.

In one instance, a new user 112, wishing to be registered, connects with the online provider 150 through the network 170 using the web browser 122. The Online Provider 150 receives information about the new user 112 which is saved in storage 152 within a user account 160 as registered user information 162. Further, the online provider 150 can receive, during registration, information about a registered user 110 so that an association between the new user 112 and the registered user 110 can be formed. This subsequent user association 164 is also stored in the user account 160 associated with the registered user 110.

Several means can be provided for the association of the new user 112 with the registered user 110 to form a user association 164. One means for associating the new user 112 with a registered user 110 is for the new user 112 to provide and identifier of the registered user 110 during registration. Another means is for the online provider to provide to the registering new user 112 a list of registered users and a means for the registering new user 112 to select from the list. In a further means for forming a user association 164, the registered user 110 specifies a list of potential new users 114. When one of the specified potential new users 114 registers as a new user 112, the association is formed automatically by the online provider 150. This is performed by comparing the new user 112 against the potential new user list 167 for all the registered user accounts 160. In one embodiment, the potential new users 167 are specified by sending electronic invitations, email for example, or a physical invitation such as a postcard. The Online Provider 150 stores in the registered user account 160 the potential new user identifiers 167.

Once the new user 112 has registered and a user association 164 formed with a registered user, an initial status level 165 is saved by the Online Provider 150 in an associated storage device 152. The status level 165 for the registered user 110 is formed and stored in the user account 160. The status level 165 can be set each time a new association 164 is made. Alternatively, the status level 165 can be formed at the time a registered user 110 accesses the Online Provider 150, or the status level 165 can be determined on a periodic basis. The status level 165 can have discrete levels where the levels change when a discrete number of user associations 164 are reached. For example, when the number of user association 164 for an associated registered user 110 exceeds a threshold, then the status level 165 is set to a new level. For an Online Provider 150, providing fashion, modeling, self-improvement content, including but not limited to videos on teenage life such as teenage dating and teen fashion, an exemplar use of the status would be for the initial status level 165 set to “Model” when first registering. After three hundred new users 112 register and three hundred new user associations 164 formed, the status level is changed to “Top Model.” When five hundred new users 112 register and five hundred new user associations 164 formed, the status level is changed to “Super Model.” Further, after two thousand new users 112 register and the associated user associations 164 formed with a registered user 110, the status level 165 is changed to “VIP Model.”

Other methods of forming a status level 165 are contemplated. The status level 165 can be a linear function of the user associations 164. An exemplar equation is shown below.

Status Level=(user association₁+ . . . +user associationₙ) Equation 1

The method can include limiting the user associations 164 to only users still registered. Thus, a status level can drop if a registered user 110 does not encourage associated users to remain registered. Further, during the registration process a time and date reference 168 can be saved in the user account 160. The time and date information can be used to determine the time period each associated registered user has been has been registered. This information can be used to form a status level 165 as a function of the amount of time the associated registered members have been registered thereby providing the ability to create incentives for bringing on new members and keeping long term users. For example, the status level 165 in one embodiment can be determined by a sum of user associations 164 time weighted by the time period 168 of the user associations 164. An equation for this calculation is shown below:

Status Level=(A₁*user association)*T₁+ . . . +*user associationₙ*Tₙ) Equation 2
Where Tₙ is the number of months the registered user associated with the user associationₙ has been an registered with the Online Provider. Aₙ is a scaling constant.
   Thresholds can also be applied to this weighted sum.

For other embodiments of the online provider 150, there can be a greater benefit for a continued attraction of new users. Thus, the status level 165 can be computed in a manner that would form an increased incentive to continue to register new users. On method of providing such an incentive is by reducing the status level by time weighting of each user association 164.

An equation that provides such result is shown below:

Status Level=(A₁*user association₁/T₁+ . . . +Aₙ*user associationₙ/Tₙ) Equation 3
Where Tₙ is the number of months the registered user associated with the user associationₙ has been an registered with the Online Provider. Aₙ is a scaling constant.

In yet another embodiment, the status level can be made a function of the status level of the users that registered. While the new user is given an initial status level, this level can change over time. Thus, by having a status level that is a function of how the associated registered users progress in their status, it provides a new kind of incentive where registered user's status improves when associated users status improves. Thus, a registered user will be incentivized to help the associated registered users to register more new users.

Status Level=(A₁*user association₁*US₁+ . . . +Aₙ*user associationₙ*USₙ) Equation 4
Where USₙ is the current status level of the user associated with user associationₙ.

The determination of a status level and incentive can be decoupled and determined independently of each other.

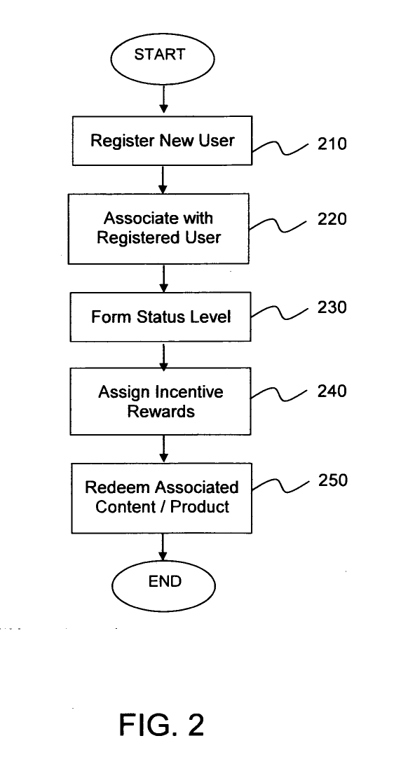

Referring now to FIG. 2, a flow diagram is shown of an exemplary process for incentivizing the registration of new users with an online provider. The flowchart is exemplary steps that would be implemented by an online provider, such as 150—FIG. 1.

At step 210, a new user is registered. The person registering can be directly connected to the online provider or can be connected through a network. In the registration step 210, the user can provide information including but not limited to name, address, profession, social group associations, political group associations, and invitation information from a registered user. Further, the online provider can provide to the registering new user information about registered users. This information can include but is not limited to lists of registered users, and attributes of registered users. The attributes can include but is not limited to address, geographic location, status level within the online provider, social affiliations, political affiliations, and professional affiliations. The registration forms a registered user account that contains information about a registered user including but not limited to user identifiers, associations with other registered users (see following discussions about user associations in step 220), status level, incentive rewards, and other potential new users that may register in the future.

At step 220, an association between the registering new user and a registered user is made. The registered user is specified during the registration step 210. The user association is stored in the user account of the registered user that was referenced during registration during the registration step or alternatively can be stored in the new user account formed for the new user. The user association can be a limited amount of information such as a count of the number of new users that have registered and referenced the registered user. Alternatively, the association can contain information including but not limited to an identifier of the new registered user, geographic information, social political or professional affiliations, or the current status level of the associated registered user. Further, the user association can include time and date information so that the length of time that the associated user has been registered can be determined.

In a step 230, a status level is determined for a registered user. An initial status level can be set at the time the user account is formed, preferably at registration time. The status level for a registered user is based on the associated registered users. The status level can be set each time a new association is made with the registered user and included with the registered user account. Alternatively, the status level can be determined at the time a registered user accesses the online provider, or the status level can be determined on a periodic basis. The status level can have discrete levels where the status levels change when a discrete number of user associations are reached. Status levels can be numerical or labels where the labels have differing social status. For example, when the number of user association for an associated registered user exceeds a threshold, then the status level is set to a new level. In an exemplar embodiment, where the method is used by an online provider of fashion, modeling, or self-improvement content, the initial status level can be set to “Model” at registration. After three hundred new users register and the user associations stored in the registered user account, the status level for the registered user is changed to “Top Model.” When a second threshold is passed, for example five hundred new users registered and associated with the registered user, the status level is changed to “Super Model.” Further when five hundred new users 112 register and two thousand new user associations 164 formed, the status level is changed to “VIP Model.” While four levels are described, more or fewer levels are contemplated. Further, while the status levels are indicated by labels, the representation of the status level as an integer or non-integer number is contemplated.

Other methods of forming a status level are contemplated in step 230. The status level can be a linear function of the user associations such as a sum. An exemplar equation is shown below:

Status Level=(user association₁+ . . . +user associationₙ)

The method can include limiting the user associations to only still registered users. Thus, a status level can be reduced if a registered user does not encourage registered users associated with his account to remain registered.

In another embodiment, during the registration process a time and date reference to when an associated user registered can be included in the registered user account. The time and date information can be used to determine the amount of time each associated registered user has been registered. This information can be used to form a status level as a function of the amount of time the associated registered members have been registered. This method of determining the status level provides the incentive to keep associated users registered so that they become more highly weighted as long term registered users. For example, the status level in one embodiment can be determined by a sum of user associations time weighted by the time period of the user associations. An equation for this calculation is as shown above in Equation 2.

For other embodiments, it may be beneficial that the forming a status level in step 230 incentivize registering new users. Thus, the status level can be determined in a manner that would form an ongoing incentive to continue to register new users. One means for doing so is to age a user association in a user account over time. Thus, a registered user's status would decrease over time unless additional new users are not registered by the registered user. An equation for forming a status level that provides such result is shown as above in Equation 3.

In yet another embodiment, the status level can be made a function of the status level of the users that registered. While the new user is given an initial status level, this level will change over time as they bring on new registered users. Thus, by having a status level that is a function of how the associated registered users progress in their status, an incentive is provided for a new structure of incentive where registered user's status improves when associated users status improve. Thus, a registered user will be incentivized to help the associated registered users increase their status level and accordingly this will increase the registration of other new users. An equation for forming a status level that provides such result is as shown above in Equation 4.

At a step 240, incentive awards are assigned to a registered user. The incentives are provided when a currently registered or enrolled user is associated with a new user joining, registering, or enrolling in a system, group, or computer based association. The incentives rewards include but are not limited to electronic reward points, incentive points, credits, payments, additional system or membership rights, access to internet or system materials including electronically streamed content, physical content provided through a physical delivery system.

The step 240 of assigning award incentives can be a function of the status level assigned to the registered user or the step 240 of assigning the incentive awards can be independent from the setting of the status level.

In one embodiment, the incentive award is a look up of a status level indicator equating to a given reward. For example, a status level of “Model” may be awarded one hundred Bratty bucks. At each successive status level, additional points, Bratty bucks for example, are awarded. The incentive awards are electronically accumulated to a registered user's electronic user account. Preferably, the reward account is an electronic database but can include custom software that stores the information in disk files or other non-volatile memory.

In another embodiment, the awards accumulate to a user account for each new user registered and associated with the registered user. Preferably, the incentives are accumulated for each unique user but can include another registration of a previously registered user. An exemplar equation for determining incentive rewards is shown below:

Incentive Awards=Incentive Awards+A*(user associationₙ).
Where A is a scaling constant and the user associationₙ is the new user registering.

The rewards can be a one-time event or provided periodically. The determination of a status level and incentive rewards can be decoupled and determined independently of each other by different formulas. By decoupling the status level and the incentive rewards, two dimensions for providing incentives are created.

In another embodiment, the incentive awards can be based on the status level as shown above in equations 2, 3, and 4. Exemplar incentive rewards are determined by the equation shown below:

Incentive Awards=A*(Status level) where the status level is determined as not equations 2, 3, or 4 above and A is a scaling constant.

In an optional step 250, incentive rewards are redeemed for physical or electronically streamed content. The incentive rewards redeemed can be electronically stored credits that are redeemable from an associated online store or can be credits in a electronic commercial payment service such as to a PayPal, or credit card provider and exchangeable for goods and services from non-associated stores.

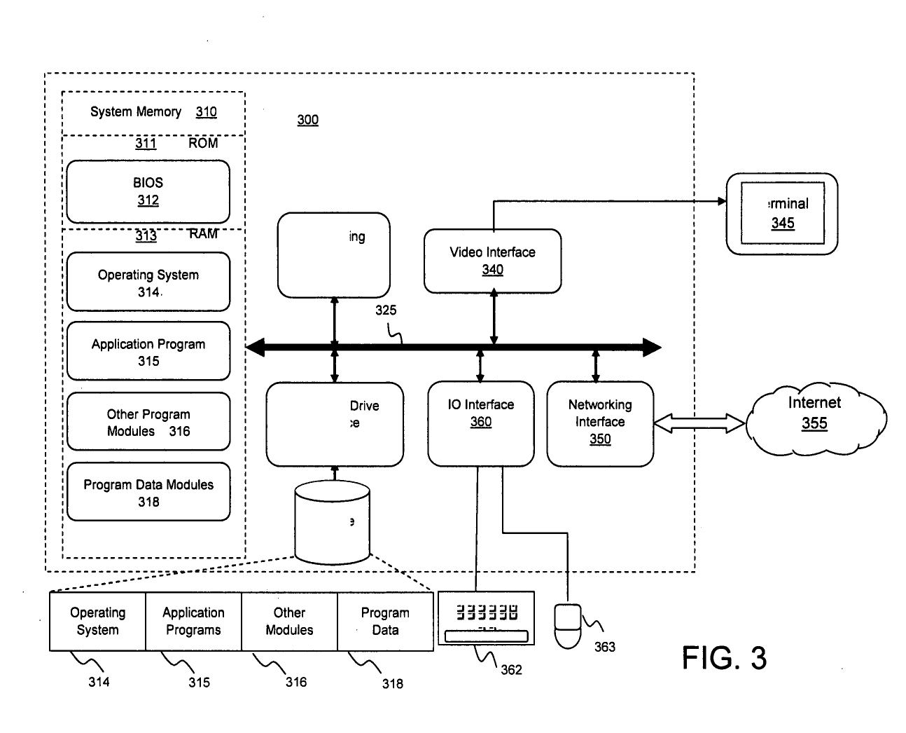

FIG. 3 illustrates an exemplary operating environment in which the online provider 150 is implemented in accordance with some embodiments of the present invention. The shown operating environment is only one example of a suitable operating environment and is not intended to suggest any limitation as to the scope of use or functionality of the invention. Other well known computing systems, environments, and configuration that may be suitable for use with the invention include, but are not limited to servers, virtual servers, personal computers, laptop devices, and multi-processors systems.

The computer server 300 is shown as one that can perform as the online provider server 150 of FIG. 1 implementing the method for user registration incentives. The computer server 300 includes one or more processors or processing units 320, a system memory 310, and a bus 325 that couples various system components including the system memory 310 to the processor 320.

The bus 325 represents one or more of any of several types of bus structures, including a memory bus or memory controller, a peripheral bus, an accelerated graphics port, and a processor or local bus using any of a variety of bus architectures. The system memory 310 includes read only memory (ROM) 311 and random access memory (RAM) 313. A basic input/output system (BIOS) 312, containing the basic routines that help to transfer information between elements within computer 300, such as during start-up, is stored in ROM 311. The computer server 300 further includes a storage drive 332 for reading from and writing to a hard disk, not shown, connected to bus 325 via a hard disk drive interface 330 (e.g., a SCSI, ATA, or other type of interface). Additionally, removable recording media is contemplated including a magnetic disk drive (not show) for reading from and writing to a removable magnetic disk (not shown), connected to bus 325 via a magnetic disk drive interface (not shown), and an optical disk drive (not shown) for reading from and/or writing to a removable optical disk such as a CD ROM, DVD, or other optical media, connected to bus 325 via an optical drive interface (not shown). The drives and their associated computer-readable media provide nonvolatile storage of computer readable instructions, data structures, program modules and other data for the computer server 300. Although the exemplary environment described herein employs a hard disk, it will be appreciated by those skilled in the art that other types of computer readable media which can store data that is accessible by a computer, such as magnetic cassettes, flash memory cards, random access memories (RAMs), read only memories (ROMs), and the like, may also be used in the exemplary operating environment.

A number of program modules may be stored on the storage 323, or magnetic disk, optical disk, ROM 311, or RAM 313, including an operating system 314, one or more application programs 315 including the recruitment metrics server application, other program modules 316, and program data 318. A user may enter commands and information into computer server 300 through input devices such as keyboard 362 and pointing device 363. Other input devices (not shown) may include a microphone, joystick, game pad, satellite dish, scanner, or the like. These and other input devices are connected to the processing unit 320 through an I/O interface 360 that is coupled to the system bus 325 (e.g., a serial port interface, a parallel port interface, a universal serial bus (USB) interface, etc.). A monitor 345 or other type of display device is also connected to the system bus 325 via an interface, such as a video adapter 340.

Reference has been made in detail to the preferred and alternative embodiments of the invention, examples of which are illustrated in the accompanying figures. While the invention has been described in conjunction with the preferred embodiments, it will be understood that they are not intended to limit the invention. It will be readily apparent to one skilled in the art that various modification may be made to the embodiments without departing from the sprit and scope of the invention as defined by the appended claims. Furthermore, in the detailed description of the present invention, numerous specific details have been set forth in order to provide a thorough understanding of the present invention. However, it should be noted that the present invention can be practiced without these specific details. In other instances, well known methods, procedures and components have not been described in detail so as not to unnecessarily obscure aspects of the present invention.

1. A method for obtaining new users of an online system within a socially networked environment comprising the steps:
means for registering a plurality of new users on an online system;
associating each of the plurality of new users with a registered user;
forming a status level as a function of the plurality of new users associated with the registered user; and
determining a reward as a function of the status level wherein the reward can be used to obtain a physical or electronic content from an online store.

2. The method of claim 1, wherein the forming the status level is a function of the sum of plurality of the new users associated with the registered user.

3. The method of claim 1, further comprising the step of:
providing each of the plurality of new users a means for selecting the registered user for the associating each of the plurality of new users with the registered user.

4. The method of claim 1, further comprising the step of:
providing each of the registered user a means for selecting the each of the plurality of new users for the associating each of the plurality of new users with the registered user.

5. The method of claim 1, wherein the status level of the registered user is visible to the plurality of new users thereby creating an incentive for the plurality of new users to obtain the status level.

6. The method of claim 2, wherein the online or physical content comprised of one or more of skin care videos make up videos, modeling videos, acting videos, personal development videos, self-improvement videos.

7. The method of claim 1, further comprising the steps of:
recording a plurality of registration timestamps for each of the plurality of users; and
computing an associated registration time duration from the plurality of registration timestamps for each of the users, wherein the forming the status level consists of a function of the sum of the products of a plurality of coefficients with number of days that each of the plurality of users have been registered.

8. The method of claim 3, wherein the online or physical content comprised of one or more of skin care videos make up videos, modeling videos, acting videos, personal development videos, self-improvement videos, teen fashion videos, and teen dating videos.

9. A system for obtaining new users for an online system comprising:
a module configured to register a plurality of new users on an online system;
a module configured to associate one or more of the plurality of new users with a registered user;
a module configured to form a status level as a function of the one or more plurality of new users associated with the registered user; and
a module configured to determining a reward as a function of the status level, wherein the reward can be used to obtain a physical or electronic content from an online store.

10. The system of claim 9, wherein the forming the status level is a function of the sum of plurality of new users registered associated with the registered user.

11. The system of claim 10, wherein the online or physical content comprised of one or more of skin care videos make up videos, modeling videos, acting videos, personal development videos, and self-improvement videos.

12. The system of claim 9, further comprising the step of:
recording a plurality of registration timestamps for each of the plurality of users; and
computing an associated registration time duration from the plurality of registration timestamps for each of the users, wherein the forming the status level consists of a function of the sum of the products of a plurality of coefficients with number of days that each of the plurality of users have been registered.

13. The system of claim 9, wherein the online or physical content comprised of one or more of skin care videos, make up videos, modeling videos, acting videos, personal development videos, self-improvement videos, teen fashion videos, and teen dating videos.

14. A computer readable medium having embodied thereon a program, the program being executable by a processor for performing the method for obtaining new users for an online system, the method comprising:
means for registering a plurality of new users on an online system;
associating each of the plurality of new users with a registered user;
forming a status level as a function of the plurality of new users associated with the registered user; and
determining a reward as a function of the status level wherein the reward can be user to obtain a physical or electronic content from an online store.

15. The apparatus of claim 14, wherein the forming the status level is a function of the sum of plurality of the new users associated with the registered user.

16. The apparatus of claim 14, further comprising the step of:
providing each of the plurality of new users a means for selecting the registered user for the associating each of the plurality of new users with the registered user.

17. The apparatus of claim 14, further comprising the step of:
providing each of the registered user a means for selecting the each of the plurality of new users for the associating each of the plurality of new users with the registered user.

18. The apparatus of claim 14, wherein the status level of the registered user is visible to the plurality of new users thereby creating an incentive for the plurality of new users to obtain the status level.

19. The apparatus of claim 14, further comprising the steps of:
recording a plurality of registration timestamps for each of the plurality of users; and
computing an associated registration time duration from the plurality of registration timestamps for each of the users, wherein the forming the status level consists of a function of the sum of the products of a plurality of coefficients with number of days that each of the plurality of users have been registered.

20. The apparatus of claim 17, wherein the online or physical content comprised of one or more of skin care videos, make up videos, modeling videos, acting videos, personal development videos, self-improvement videos, teen fashion videos, and teen dating videos.
